(19) United States
(12) Patent Application Publication
(10) Pub. No.: US 2014/0310087 A1
(43) Pub. Date: Oct. 16, 2014

(54) METHOD AND SYSTEM FOR PROCESSING REPORT INFORMATION

(71) Applicant: TENCENT TECHNOLOGY (SHENZHEN) COMPANY LIMITED, Shenzhen (CN)

(72) Inventors: DEXIN SU, Shenzhen (CN); YI TANG, Shenzhen (CN)

(73) Assignee: TENCENT TECHNOLOGY (SHENZHEN) COMPANY LIMITED, Shenzhen (CN)

(21) Appl. No.: 14/250,686

(22) Filed: Apr. 11, 2014

Related U.S. Application Data
(63) Continuation of application No. PCT/CN2013/088027, filed on Nov. 28, 2013.

(30) Foreign Application Priority Data
Apr. 15, 2013 (CN) 2013101305286

(51) Int. Cl. H04L 12/26; G06Q 30/02

(52) U.S. Cl. CPC H04L 43/062; G06Q 30/0231
USPC 705/14.31; 709/224

(57) ABSTRACT

Methods and systems for processing report information are provided herein. An exemplary method can be implemented by a computer system. The method can include receiving a reporting from an informer. The informer can submit report information including at least a user identification (ID) of a reported person. It can be determined whether the reporting is valid, according to the user ID of the reported person. When the reporting is valid, the reported person can be punished according to a preset punishment strategy. First feedback information indicating a valid reporting can be sent to the informer, and second feedback information indicating reasons for punishing can be sent to the reported person. When the reporting is invalid, third feedback information indicating an invalid reporting can be sent to the informer.

### CROSS-REFERENCES TO RELATED APPLICATIONS

This application is a continuation application of PCT Patent Application No. PCT/CN2013/088027, filed on Nov. 28, 2013, which claims priority to Chinese Patent Application No. 201310130528.6, filed on Apr. 15, 2013, the entire contents of all of which are incorporated herein by reference.

### FIELD OF THE DISCLOSURE

The present disclosure generally relates to communication technology and, more particularly, relates to methods and systems for processing report information.

### BACKGROUND

With development of network technology, network activities have become increasingly diverse. Meanwhile, some illegal network activities may occur frequently. An important part of network security is how to prevent those illegal network activities from affecting normal network activities.

In existing technology, user reporting is a very important source of information for network-side to be informed of network illegal activities. When the network-side receives report information from a user, the report information is generally analyzed and audited manually. A situation submitted by the report information is then further processed, for example, with certain punishment according to the report information.

Because the report information can only be analyzed and audited manually, significant labor cost is used and the processing efficiency is low.

### BRIEF SUMMARY OF THE DISCLOSURE

One aspect of the present disclosure includes a method for processing report information. An exemplary method can be implemented by a computer system. The method can include receiving a reporting from an informer. The informer can submit report information including at least a user identification (ID) of a reported person. It can be determined whether the reporting is valid, according to the user ID of the reported person. When the reporting is valid, the reported person can be punished according to a preset punishment strategy. First feedback information indicating a valid reporting can be sent to the informer, and second feedback information indicating reasons for punishing can be sent to the reported person. When the reporting is invalid, third feedback information indicating an invalid reporting can be sent to the informer.

Another aspect of the present disclosure includes a system for processing report information. The system can include a receiving unit, a determination unit, a first processing unit, and a second processing unit. The receiving unit can be configured to receive a reporting submitted by an informer. The informer can submit report information including at least a user ID of a reported person. The determination unit can be configured to determine whether the reporting is valid, according to the user ID of the reported person. When the reporting is valid, the first processing unit can be configured to punish the reported person according to a preset punishment strategy, to send to the informer first feedback information indicating a valid reporting, and to send to the reported person second feedback information indicating reasons for punishing. When the reporting is invalid, the second processing unit can be configured to send to the informer third feedback information indicating an invalid reporting.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a flow diagram of an exemplary method for processing report information in accordance with various disclosed embodiments;

FIG. 2 depicts a flow diagram of another exemplary method for processing report information in accordance with various disclosed embodiments;

FIG. 3 depicts a flow diagram of another exemplary method for processing report information in accordance with various disclosed embodiments;

FIG. 4a depicts a structure diagram of an exemplary system for processing report information in accordance with various disclosed embodiments;

FIG. 4b depicts a structure diagram of another exemplary system for processing report information in accordance with various disclosed embodiments;

FIG. 5 depicts a structure diagram of an exemplary server in accordance with various disclosed embodiments;

FIG. 6 depicts an exemplary environment incorporating certain disclosed embodiments; and

FIG. 7 depicts an exemplary computing system consistent with the disclosed embodiments.

### DETAILED DESCRIPTION

Reference will now be made in detail to exemplary embodiments of the disclosure, which are illustrated in the accompanying drawings.

FIG. 6 depicts an exemplary environment 600 incorporating exemplary methods and systems for processing report information in accordance with various disclosed embodiments. As shown in FIG. 6, the environment 600 can include a server 604, a terminal 606, and a communication network 602. The server 604 and the terminal 606 may be coupled through the communication network 602 for information exchange including, e.g., sending/receiving report information, feedback information, alert messages, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., receiving report information, data collecting, data searching, sending feedback information/alert messages, process rewards/punishments for users, etc. A server may also include one or more processors to execute computer programs in parallel.

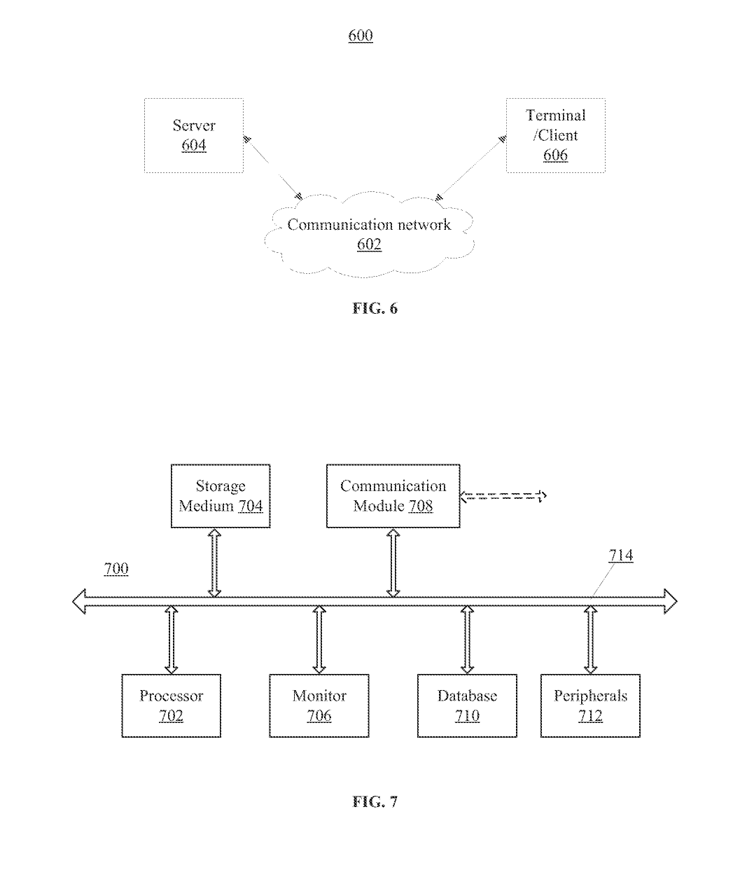

The server 604 and the terminal 606 may be implemented on any appropriate computing platform. FIG. 7 shows a block diagram of an exemplary computing system 700 (or computer system 700) capable of implementing the server 604 and/or the terminal 606. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, e.g., Read-Only Memory (ROM), Random Access Memory (RAM), and flash memory modules, and mass storages, e.g., CD-ROM, U-disk, removable hard disk, etc. The storage medium 704 may store computer programs for implementing various processes (e.g., receiving report information, processing report information, etc.), when executed by the processor 702.

The monitor 706 may include display devices for displaying contents in the computing system 700, e.g., displaying report information or game interface. The peripherals 712 may include I/O devices such as keyboard and mouse.

Further, the communication module 708 may include network devices for establishing connections through the communication network 602. The database 710 may include one or more databases for storing certain data and for performing certain operations on the stored data, e.g., storing abnormal data, user IDs, and corresponding relationship(s) there between, or any other suitable data searching and management operations.

In operation, the terminal 606 may cause the server 604 to perform certain actions, e.g., receiving report information from a user terminal, returning feedback information, sending alert messages, etc. The server 604 may be configured to provide structures and functions for such actions and operations. More particularly, the server 604 may include a management server, a messaging server, a mail server, or any other suitable servers for corresponding functions.

In various embodiments, a terminal involved in the disclosed methods and systems can include the terminal 606, while a server involved in the disclosed methods and systems can include the server 604. The methods and systems disclosed in accordance with various embodiments can be executed by a computer system. In one embodiment, the disclosed methods and systems can be implemented by a server.

Various embodiments provide methods and systems for processing report information. The methods and systems are illustrated in various examples described herein.

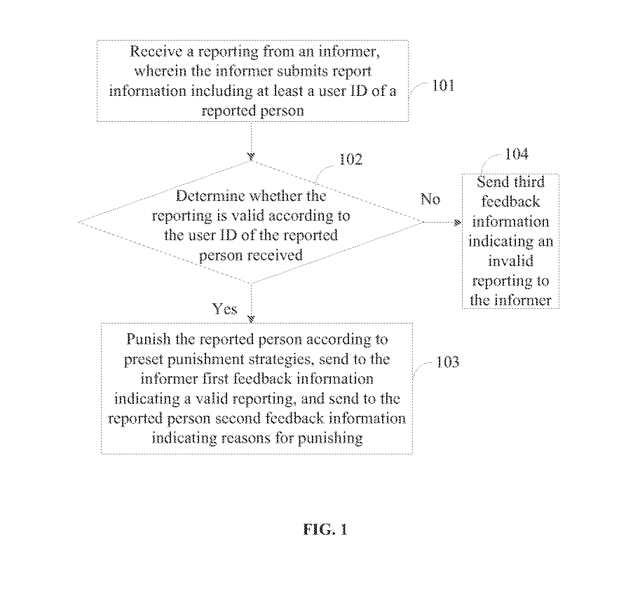

FIG. 1 depicts a flow diagram of an exemplary method for processing report information in accordance with various disclosed embodiments. In various embodiments, the exemplary method can be implemented by a system for processing report information. The system can be integrated in a network-side device, e.g., a management server, or any other suitable devices.

A method for processing report information can include receiving a reporting from an informer. The informer can submit report information including at least a user identification (ID) of a reported person. According to the user ID of the reported person, it can be determined whether the reporting is valid or not. If the reporting is valid, the reported person can be processed or punished according to preset punishment strategies. First feedback information indicating a valid reporting can be sent to the informer, and second feedback information indicating reasons for punishing can be sent to the reported person. If the reporting is invalid, third feedback information indicating an invalid reporting can be sent to the informer. Referring to FIG. 1, the method can include the following exemplary steps.

In Step 101, a reporting from an informer is received, when report information submitted by an informer is received. For example, the report information can include at least a user ID of a reported person. The report information may further include other information, e.g., reasons for reporting, and any other suitable information. As used herein, the submitting of the report information can be referred to as an action of ‘reporting’. Thus, receiving report information submitted by an informer can be referred to as receiving a ‘reporting’ from the informer. In various embodiments, the reported person can refer to a person who has to be punished for his/her activities, according to the report information and/or any suitable rules of a specific network activity system (e.g., a game system).

The user ID can be in various forms including, e.g., mobile phone number, email address, nickname, etc. The user ID may include one ID, and/or a plurality of user sub-IDs. For example, for a certain game, the user ID may include identifier(s), e.g., user account, game area code, role name. etc. A user account may include mobile phone number(s), email address(es), nickname(s), etc.

In Step 102, it is determined whether the reporting is valid, according to the user ID of the reported person (e.g., as in Step 101). If the reporting is valid, Step 103 can be performed. Otherwise, if the reporting is invalid, Step 104 can be performed.

As used herein, the submitting of the report information according to various embodiments (e.g., as in Step 101) can be referred to as an action of ‘reporting’. Accordingly, determining whether the reporting is valid can include determining whether the report information is valid.

For example, it can be determined whether the user ID of the reported person is in a first database. When the user ID of the reported person is in the first database, the reporting is determined to be valid and Step 103 can be performed. Otherwise, when the user ID of the reported person is not in the first database, the reporting is determined to be invalid, and Step 104 can be performed.

In various embodiments, the first database can store a corresponding relationship or corresponding relationships between abnormal data and user IDs that is previously submitted by one or more application servers. That is, before receiving report information submitted by an informer (e.g., as in Step 101), the method may further include the following steps. For example, the abnormal data and the user IDs can be submitted by various application servers. The corresponding relationship between the abnormal data and the user IDs can then be stored in the first database according to the abnormal data and the user IDs. Accordingly, information in the first database can be added, deleted, and updated, according to the abnormal data and the user IDs submitted by the various application servers. In various embodiments, a corresponding relationship between abnormal data and user IDs can include any correlation between various abnormal data and the user IDs. For example, when the abnormal data includes an illegal operation. The abnormal data can have a correlation (i.e., a corresponding relationship) with a user ID when the illegal operation is performed by the user ID according to information submitted by any of the one or more application servers.

It should be noted that, criteria for determining the abnormal data can be set according to needs of practical applications. For example, for a certain game, the abnormal data can include user cheating information that is detected, or any other suitable information. For a certain application, the abnormal data may include some illegal operation information, or any other suitable information.

Optionally, because there can be a certain delay when the various application servers report the abnormal data and the user IDs, the following scenario may occur. For example, when a user reports the report information, although facts in the report information actually exist, there may be no related records in the first database. The reporting can be determined to be invalid. Therefore, in order to further effectively use the submitted information and avoid mistakes, when it is determined that the user ID of the reported person is not in the first database, a certain period of delay time can be waited. After waiting for this certain period of delay time, e.g., a preset period of time, it can be determined again whether the user ID of the reported person is in the first database. That is, during the preset period of time, the first database can be detected for one or more times, in order to determine whether the user ID of the reported person is in the first database. When the user ID of the reported person still cannot be found in the first database after the preset period of time elapses, the reporting can then be determined to be invalid.

Step 102 can thus include the following steps. For example, it can be determined whether the user ID of the reported person is in the first database. When the user ID of the reported person is in the first database, the reporting can be determined to be valid and Step 103 can be performed. Otherwise, when the user ID of the reported person is not in the first database, the step of determining whether the user ID of the reported person is in the first database can be repeatedly performed within a preset period of time. When the user ID of the reported person is still not in the first database after the preset period of time elapses, the reporting can then be determined to be invalid and Step 104 can be performed.

The preset period of time can be set according to needs of actual applications. In one embodiment, during the preset period of time, the first database can be detected (i.e., to determine whether the user ID of the reported person is in the first database) at a certain preset frequency. In another embodiment, in order to save signaling process, the first database can be detected (i.e., to determine whether the user ID of the reported person is in the first database) when it is determined that the first database has been changed.

When the user ID includes a plurality of user sub-IDs, the step of determining whether the user ID of the reported person is in the first database can include the following steps. For example, it can be determined whether the plurality of user sub-IDs of the reported person are simultaneously in the first database. When the plurality of user sub-IDs of the reported person are simultaneously in the first database, the user ID of the reported person can be determined to be in the first database. When the plurality of user sub-IDs of the reported person are not simultaneously in the first database, the user ID of the reported person can be determined not to be in the first database.

For example, when the user ID includes identifier(s), e.g., user account, game area code, role name, etc, it can be determined whether the user account, game area code, and/or role name are simultaneously in the first database. When the user account, game area code, and/or role name are simultaneously in the first database, the user ID of the reported person can be determined to be in the first database. Otherwise, when the user account, game area code, and/or role name are not simultaneously in the first database, the user ID of the reported person can be determined not to be in the first database.

However, criteria for determining whether the user ID of the reported person is in the first database can be set according to needs of actual applications, and are not limited in the present disclosure. For example, in one embodiment, when one or a desired number of the plurality of user sub-IDs of the reported person are in the first database, the user ID of the reported person can be determined to be in the first database. When none of the plurality of user sub-IDs of the reported person is in the first database, the user ID of the reported person can be determined not to be in the first database.

In Step 103, when the reporting is determined to be valid, the reported person is punished according to a present punishment strategy (or preset punishment strategies), and feedback information is sent to the informer and the reported person, respectively. For example, feedback information indicating a valid reporting can be sent to the informer, and feedback information indicating reasons for punishing can be sent to the reported person. For purposes of illustration, the feedback information indicating the valid reporting can be referred to as first feedback information, and the feedback information indicating the reasons for punishing can be referred to as second feedback information. As used herein, ‘feedback information’ can also be referred to as ‘feedback message’.

For example, the first feedback information indicating the valid reporting can be sent to the informer via a messaging server and/or a mail server. The second feedback information indicating the reasons for punishing can be sent to the reported person via the messaging server and/or the mail server. The preset punishment strategies can be set according to needs of actual applications.

In Step 104, when the reporting is determined to be invalid, feedback information indicating an invalid reporting can be sent to the informer. For convenience of description, in various embodiments, the feedback information indicating the invalid reporting can be referred to as third feedback information. In various embodiments, the third feedback information indicating the invalid reporting can be sent to the informer via the messaging server and/or the mail server.

Optionally, the informer can be rewarded automatically or as programmed. That is, after the first feedback information indicating the valid reporting is sent to the informer, the method can further include the following steps. For example, an account of the informer (i.e., an account that the informer belongs to) can be obtained. Points can be added to the account of the informer. Total points can be calculated. When the total points are determined to exceed a point threshold corresponding to a preset reward level, a reward code corresponding to the preset reward level can be sent to the informer. In one embodiment, the reward code corresponding to the preset reward level can include a registration code (e.g., CD-KEY). In addition, points corresponding to the preset reward level (e.g., points corresponding to the point threshold, or any other suitable amount of points according to the reward strategies) can be deducted from the total points. The reward code can be sent in various ways including, e.g., sent to the informer via short messages, sent to the informer via mails (postal mail, email, or any other suitable forms of mail), etc.

In addition, when the total points are determined not to exceed a point threshold corresponding to a preset reward level, no actions need to be taken. Alternatively, in this case, an alert message can be sent to the user (i.e., the informer) to inform him/her that the current total points are not yet enough to redeem rewards, or inform him/her of any other suitable information.

One alert message can be sent, for illustration purposes. However, one or more alert messages can be sent to achieve the purposes of notifying the informer of any processes, which is not limited in the present disclosure.

In addition, optionally, the reward strategies can include one or more preset reward levels. Each preset reward level can have a certain point threshold, respectively. The determining of whether the total points exceed a point threshold corresponding to a preset reward level can be implemented in various ways according to needs of actual applications, without limitation.

In one example, an informer can pre-select a desired preset reward level, or the system can set a default preset reward level for reward, such that the total points can automatically be compared with the point threshold of that preset reward level. In this case, when the total points do not exceed the preset reward level, it can be determined that the total points do not exceed a point threshold of a preset reward level. When the total points exceed the preset reward level, it can be determined that the total points exceed a point threshold according to a preset reward level.

In another example, the total points can be compared with one or more preset reward levels. When the total points do not exceed any one of the preset reward levels, it can be determined that the total points do not exceed a point threshold of a preset reward level. When the total points exceed one or more preset reward levels, it can be determined that the total points exceed a point threshold of a preset reward level (i.e., at least exceed the point threshold of one preset reward level). In this case, optionally, the informer can then receive an alert message notifying him/her of the one or more present reward levels. The informer can choose his/her desired preset reward level from the one or more present reward levels, such that a reward code corresponding to the chosen preset reward level can be sent to the informer.

Reward strategies can be set according to needs of actual applications. For example, it can be set that, every day after zero o'clock at mid night, an apparatus/system for processing report information corresponding to the method for processing report information can perform statistical analysis, e.g., count a reporting number of a previous day. The report number can refer to a total number of times that report information is received. Types of reporting can be divided into regular reporting and special reporting. When the reporting is a routine reporting, corresponding points can be added to each reporting user (e.g., each informer). When the reporting is a special reporting, corresponding points can be added to a user (e.g., informer) that is the first to report an illegal operation (i.e., a phenomenon that can be reported by submitting report information).

For example, when user A is reported by about 4 informers and accordingly receives a punishment, total points brought by the punishment can be about 100 points. Thus, when the reporting is a routine reporting, each informer can be added by about 25 points on the next day for the reporting, i.e., the total points evenly divided by the number of informers. When the reporting is a special reporting, the points (e.g., the total of about 100 points) can only be added to the first informer. The reward strategies can include any other suitable reward strategies, without limitation.

According to various disclosed embodiments, a reporting from an informer can be received when the informer submits report information including at least a user ID of a reported person. According to the user ID of the reported person, it can be determined whether the reporting is valid or not. When the reporting is valid, the reported person can be punished according to preset punishment strategies, first feedback information indicating a valid reporting can be sent to the informer, and second feedback information indicating reasons for punishing can be sent to the reported person. When the reporting is invalid, third feedback information indicating an invalid reporting can be sent to the informer. Thus, the report information can be automatically processed. Problems of high labor cost and low efficiency (caused by manually analyzing and auditing of the report information) can be solved. Thus, labor cost can be saved, and processing efficiency can be significantly improved.

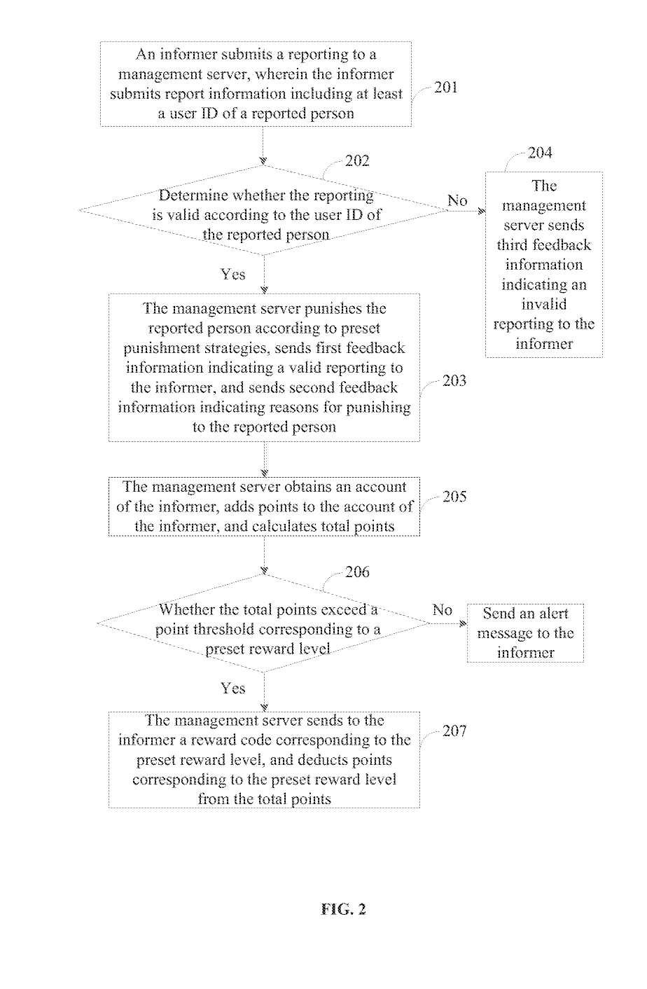

Based on various disclosed embodiments (e.g., as shown in FIG. 1), the methods for processing report information can be further detailed as following. In one embodiment, a system for processing report information can be integrated in a management server. For example, FIG. 2 depicts a flow diagram of another exemplary method for processing report information in accordance with various disclosed embodiments. The method can include the following exemplary steps.

In Step 201, an informer submits a reporting, i.e., submits report information to a management server. For example, the informer can submit the report information to the management server via a terminal. The report information can include at least a user ID of a reported person. The report information may further include other information, e.g., reasons for reporting, and/or any other suitable information.

The user ID can be in various forms including, e.g., mobile phone number, email address, nickname, etc. The user ID may include one ID, and/or a plurality of user sub-IDs. For example, for a certain game, the user ID may include identifier(s), e.g., user account, game area code, role name, etc. A user account may include mobile phone number(s), email address(es), nickname(s), etc.

For example, in a K game, when user A finds that user B is cheating, then at this time, user A can submit the report information to the management server. The report information can include a user ID of user B including identifier(s), e.g., user account, game area code, and/or role name. In addition, the submitted information can include the reasons for reporting, e.g., specifying that user B is cheating, and/or other suitable information. In this example, user A can be an informer and user B can be a reported person.

In Step 202, after the management server receives the report information, the management server determines whether reporting is valid. For example, the management server can determine whether the user ID of the reported person is in a first database. When the user ID of the reported person is in the first database, the reporting is determined to be valid and Step 203 can be performed. Otherwise, when the user ID of the reported person is not in the first database, the reporting is determined to be invalid and Step 204 can be performed.

In various embodiments, the first database can store a corresponding relationship between abnormal data and user IDs that is previously submitted by one or more application servers. For example, the abnormal data and the user IDs can be submitted by various application servers. The corresponding relationship between the abnormal data and the user IDs can then be stored in the first database according to the abnormal data and the user IDs.

For example, when the user ID includes a plurality of user sub-IDs, it can be determined whether the plurality of user sub-IDs of the reported person are simultaneously in the first database. When the plurality of user sub-IDs of the reported person are simultaneously in the first database, the reporting can be determined to be valid. When the plurality of user sub-IDs of the reported person are not simultaneously in the first database, the reporting can be determined to be invalid.

In the example involving the K game, when the user ID of the reported person (e.g., user B) includes identifier(s) of user B, e.g., user account, game area code, and/or role name, it can be determined whether the identifier(s) of user B including the user account, game area code, and/or role name are simultaneously in the first database. When the user account, game area code, and/or role name are simultaneously in the first database, the reporting can be determined to be valid. Otherwise, when the user account, game area code, and/or role name are not simultaneously in the first database, the reporting can be determined to be invalid.

In Step 203, when the reporting is determined to be valid, the management server can punish the reported person according to preset punishment strategies, send first feedback information indicating a valid reporting to the informer, and send second feedback information indicating reasons for punishing to the reported person.

For example, via a messaging server and/or a mail server, the first feedback information indicating the valid reporting can be sent to the informer and the second feedback information indicating the reasons for punishing can be sent to the reported person. That is, the first feedback information and the second feedback information can be in messages, mails, and/or any other suitable forms.

In Step 204, when the reporting is determined to be invalid, third feedback information indicating an invalid reporting can be sent to the informer. For example, the third feedback information indicating the invalid reporting can be sent to the informer via the messaging server and/or the mail server.

Optionally, the informer can be rewarded automatically or as programmed. That is, after the first feedback information indicating the valid reporting is sent to the informer, the method can further include the following steps. For example, in Step 205, the management server can obtain an account of the informer (i.e., an account that the informer belongs to), add points to the account of the informer, and calculate total points. Optionally, at this time, the management server can send an alert message to the user (i.e., the informer) to notify him/her of the reward situation.

In Step 206, the management server determines whether the total points exceed a point threshold corresponding to a preset reward level. When the total points do not exceed a point threshold corresponding to a preset reward level, no actions need to be taken. Alternatively, in this case, an alert message can be sent to the user (i.e., the informer) to inform him/her that the current total points are not yet enough to redeem rewards. When the total points exceed a point threshold corresponding to a preset reward level, Step 207 can be performed. The point threshold can be set according to the specific application, without limitation.

In Step 207, the management server sends to the informer a reward code corresponding to the preset reward level, and deducts points corresponding to the preset reward level (e.g., points corresponding to the point threshold, or any other suitable amount of points) from the total points. Optionally, at this time, the management server can further send an alert message to the user (i.e., the informer) to inform him/her of point deduction situation.

According to various disclosed embodiments, a reporting from an informer can be received, when the informer submits report information including at least a user ID of a reported person. According to the user ID of the reported person, it can be determined whether the reporting is valid or not. When the reporting is valid, the reported person can be punished according to preset punishment strategies, first feedback information indicating a valid reporting can be sent to the informer, and second feedback information indicating reasons for punishing can be sent to the reported person. When the reporting is invalid, third feedback information indicating an invalid reporting can be sent to the informer. Thus, the report information can be automatically processed. Problems of high labor cost and low efficiency (caused by manual analyzing and auditing of the report information) can be solved. Thus, labor cost can be saved, and processing efficiency can be significantly improved.

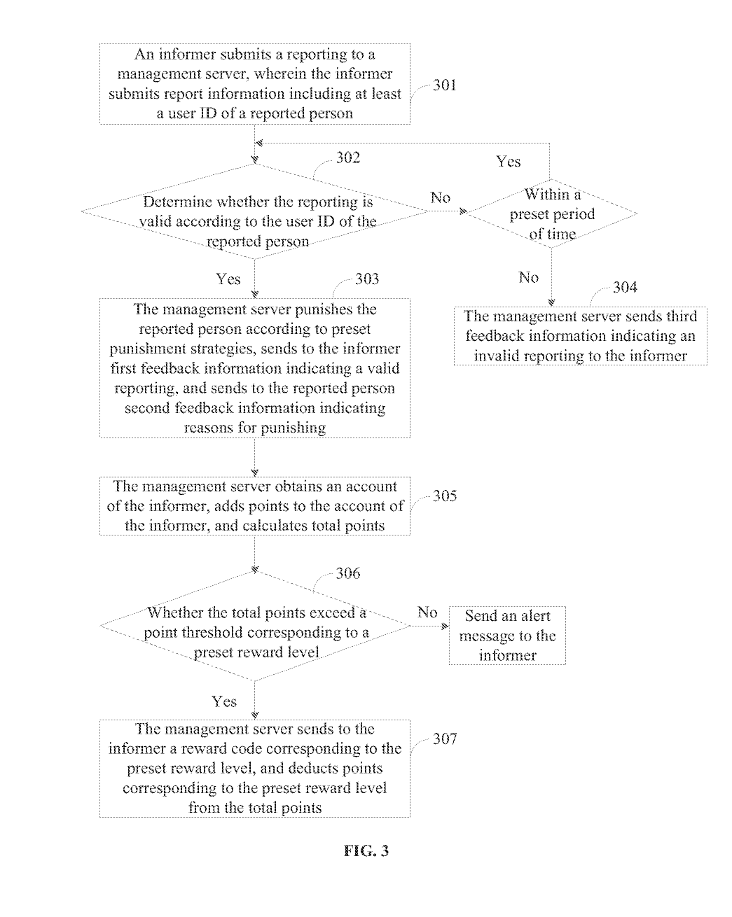

FIG. 3 depicts a flow diagram of another exemplary method for processing report information in accordance with various disclosed embodiments. In this example, a system for processing report information can be integrated in a management server. This example can be similar to other examples depicted above in various embodiments (e.g., FIG. 2). However, when the user ID of the reported person is not in a first database, the reporting is not directly determined to be invalid. Instead, the determining can be performed again after waiting for a certain period of delay time. Referring to FIG. 3, the method can include the following exemplary steps.

In Step 301, an informer submits report information to a management server, and thus the management server receives a reporting. For example, the informer can submit the report information to the management server via a terminal. The report information can include at least a user ID of a reported person. The report information may further include other information, e.g., reasons for reporting, and/or any other suitable information.

The user ID can be in various forms including, e.g., mobile phone number, email address, nickname, etc. The user ID may include one ID, and/or a plurality of user sub-IDs. For example, for a certain game, the user ID may include identifier(s), e.g., user account, game area code, role name, etc. A user account may include mobile phone number(s), email address(es), nickname(s), etc.

For example, in a K game, when user A finds that user B is cheating, then at this time, user A can submit the report information to the management server. The report information can include a user ID of user B including identifier(s), e.g., user account, game area code, and/or role name. In addition, the submitted information can include the reasons for reporting, e.g., specifying that user B is cheating, and/or other suitable information. In this example, user A can be an informer and user B can be a reported person.

In Step 302, after the management server receives the report information, the management server determines whether the user ID of the reported person is in a first database. When the user ID of the reported person is in the first database, the reporting is determined to be valid, and Step 303 can be performed. Otherwise, when the user ID of the reported person is not in the first database, the step of determining whether the user ID of the reported person is in the first database can be repeatedly performed within a preset period of time. When the user ID of the reported person still cannot be found in the first database after the preset period of time. That is, when the user ID of the reported person still cannot be found in the first database after the preset period of time elapses, the reporting can then be determined to be invalid, and Step 304 can be performed. When, the user ID of the reported person is detected to be in the first database within the preset period of time, the reporting can then be determined to be valid, and Step 303 can be performed.

The preset period of time can be set according to needs of actual applications. In various embodiments, the first database can store a corresponding relationship between abnormal data and user IDs that is previously submitted by various application servers. For example, the management server can receive the abnormal data and the user IDs from the various application servers, and then store in the first database the corresponding relationship between the abnormal data and the user IDs according to the abnormal data and the user IDs.

In various embodiments, when the user ID includes a plurality of user sub-IDs, it can be determined whether the plurality of user sub-IDs of the reported person are simultaneously in the first database. When the plurality of user sub-IDs of the reported person are simultaneously in the first database, the reporting can be determined to be valid. When the plurality of user sub-IDs of the reported person are not simultaneously in the first database, the reporting can be determined to be invalid.

Take the K game as an example. When the user ID of the reported person (e.g., user B) includes identifier(s) of user B, e.g., user account, game area code, and/or role name, it can be determined whether the identifier(s) of user B including the user account, game area code, and/or role name are simultaneously in the first database. When the user account, game area code, and/or role name are simultaneously in the first database, the reporting can be determined to be valid. Otherwise, when the user account, game area code, and/or role name are not simultaneously in the first database, the reporting can be determined to be invalid.

In Step 303, when the reporting is determined to be valid, the management server can punish the reported person according to preset punishment strategies, send first feedback information indicating a valid reporting to the informer, and send second feedback information indicating reasons for punishing to the reported person.

For example, via a messaging server and/or a mail server, the first feedback information indicating the valid reporting can be sent to the informer and the second feedback information indicating the reasons for punishing can be sent to the reported person. That is, the first feedback information and the second feedback information can be in messages, mails, and/or any other suitable forms.

In Step 304, when the reporting is determined to be invalid, third feedback information indicating an invalid reporting can be sent to the informer. For example, the third feedback information indicating the invalid reporting can be sent to the informer via the messaging server and/or the mail server.

Optionally, the informer can be rewarded automatically. That is, after the first feedback information indicating the valid reporting is sent to the informer, the method can further include the following steps. For example, in Step 305, the management server can obtain an account of the informer (i.e., an account that the informer belongs to), add points to the account of the informer, and calculate total points. Optionally, at this time, the management server can send an alert message to the user (i.e., the informer) to notify him/her of the reward situation.

In Step 306, the management server determines whether the total points exceed a point threshold corresponding to a preset reward level. When the total points do not exceed a point threshold corresponding to a preset reward level, no actions need to be taken. Alternatively, in this case, an alert message can be sent to the user (i.e., the informer) to inform him/her that the current total points are not yet enough to redeem rewards. When the total points exceed a point threshold corresponding to a preset reward level, Step 307 can be performed. Reward strategies can be set according to needs of actual applications.

In Step 307, the management server sends to the informer a reward code corresponding to the preset reward level, and accordingly deduct points corresponding to the preset reward level (e.g., points corresponding to the point threshold, or any other suitable amount of points) from the total points. Optionally, at this time, the management server can further send an alert message to the user (i.e., the informer) to inform him/her of point deduction situation.

According to various disclosed embodiments, a reporting from an informer can be received. The informer can submit report information including at least a user ID of a reported person. According to the user ID of the reported person, it can be determined whether the reporting is valid or not. When the reporting is valid, the reported person can be punished according to preset punishment strategies, first feedback information indicating a valid reporting can be sent to the informer, and second feedback information indicating reasons for punishing can be sent to the reported person. When the reporting is invalid, third feedback information indicating an invalid reporting can be sent to the informer. Thus, the report information can be automatically processed. Problems of high labor cost and low efficiency (caused by manually analyzing and auditing the report information) can be solved. Thus, labor cost can be saved, and processing efficiency can be significantly improved.

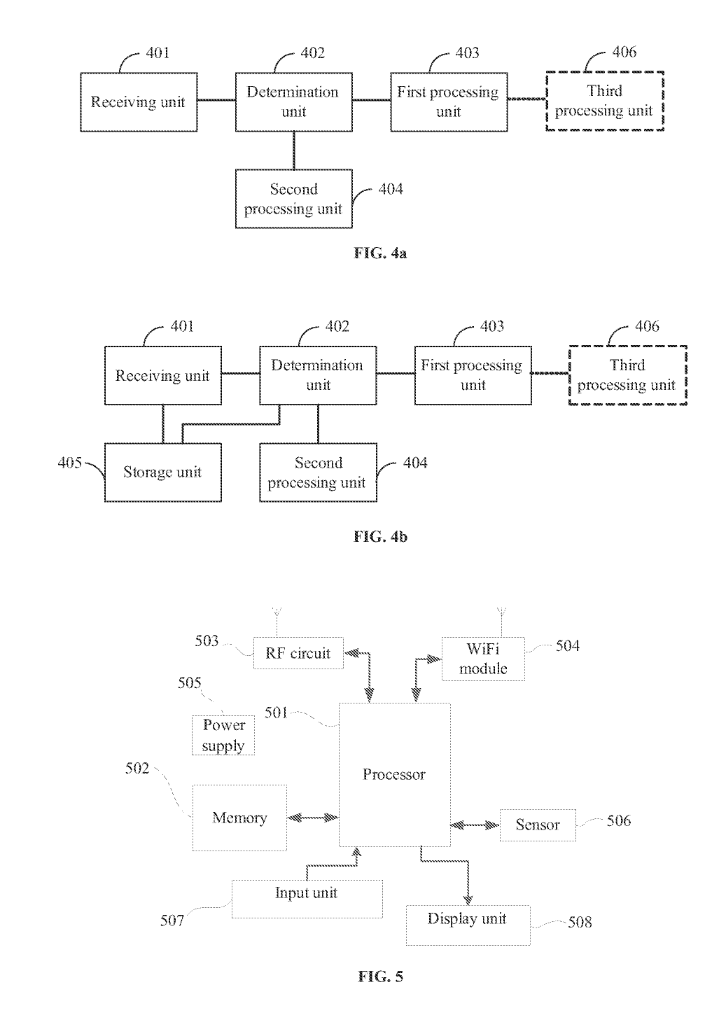

Accordingly, various embodiments provide a system for processing report information. FIG. 4a depicts a structure diagram of an exemplary system for processing report information in accordance with various disclosed embodiments. The system for processing report information can include a receiving unit 401, a determination unit 402, a first processing unit 403, and/or a second processing unit 404. Some units may be omitted and other units may be included.

The receiving unit 401 is configured to receive a reporting (i.e., report information) submitted by an informer. For example, the report information can include at least a user ID of a reported person. The report information may further include other information, e.g., reasons for reporting, and any other suitable information.

The user ID can be in various forms including, e.g., mobile phone number, email address, nickname, etc. The user ID may include one ID, and/or a plurality of user sub-IDs. For example, for a certain game, the user ID may include identifier(s), e.g., user account, game area code, role name, etc. A user account may include mobile phone number(s), email address(es), nickname(s), etc.

The determination unit 402 is configured to determine whether the reporting is valid. When the determination unit 402 determines that the reporting is valid, the first processing unit 403 is configured to punish the reported person according to preset punishment strategies, send first feedback information indicating a valid reporting to the informer, and send second feedback information indicating reasons for punishing to the reported person. The preset punishment strategies can be set according to needs of actual applications. The second processing unit 404 is configured to send to the informer third feedback information indicating an invalid reporting, when the determination unit 402 determines that the reporting is invalid.

For example, when the determination unit 402 determines that the reporting is valid, the first processing unit 403 is configured to punish the reported person according to the preset punishment strategies, send the first feedback information indicating the valid reporting to the informer via a messaging server and/or a mail server, and send the second feedback information indicating the reasons for punishing to the reported person via the messaging server and/or the mail server.

The second processing unit 404 is configured to send to the informer the third feedback information indicating the invalid reporting via the messaging server and/or the mail server, when the determination unit 402 determines that the reporting is invalid.

Optionally, the determination unit 402 can be configured to determine whether the user ID of the reported person is in a first database. When the user ID of the reported person is in the first database, the reporting is valid. Otherwise, when the user ID of the reported person is not in the first database, the reporting is invalid.

In various embodiments, the first database can store a corresponding relationship between abnormal data and user IDs that is previously submitted by one or more application servers. For example, FIG. 4b depicts a structure diagram of another exemplary system for processing report information in accordance with various disclosed embodiments. As shown in FIG. 4b, the system for processing report information can further include a storage unit 405.

The receiving unit 401 is further configured to receive the abnormal data and the user IDs submitted by the one or more application servers. The storage unit 405 is configured to store in the first database the corresponding relationship between the abnormal data and the user IDs, according to the abnormal data and the user IDs received by the receiving unit 401. Accordingly, information in the first database can be added, deleted and updated according to the abnormal data and the user IDs submitted by the one or more application servers.

In various embodiments, criteria for determining the abnormal data can be set according to needs of practical applications. For example, for a certain game, the abnormal data can include user cheating information that is detected, or any other suitable information. For a certain application, the abnormal data may include some illegal operation information, or any other suitable information.

Optionally, because there can be a certain delay when the various application servers submit the abnormal data and the user IDs, the following scenario may occur. For example, when a user submits the report information, although facts in the report information actually exist, there may be no related records in the first database, so the reporting can be determined to be invalid. Therefore, in order to further effectively use the submitted information and avoid mistakes, when it is determined that the user ID of the reported person is not in the first database, a certain period of delay time can be waited. It can then be determined again whether the user ID of the reported person is in the first database in the first database. That is, during a preset period of time, the first database can be detected for one or more times, in order to determine whether the user ID of the reported person is in the first database. When the user ID of the reported person still cannot be found in the first database after the preset period of time elapses, the reporting can then be determined to be invalid.

In this case, the determination unit 402 is configured to determine whether the user ID of the reported person is in the first database. When the user ID of the reported person is in the first database, the reporting can be determined to be valid. When the user ID of the reported person is not in the first database, the step of determining whether the user ID of the reported person is in the first database can be repeatedly performed within a preset period of time. When, after the preset period of time, the user ID of the reported person is still not in the first database, the reporting can then be determined to be invalid. The preset period of time can be set according to needs of actual applications.

In addition, when the user ID includes a plurality of user sub-IDs, it can be determined whether the plurality of user sub-IDs of the reported person are simultaneously in the first database. When the plurality of user sub-IDs of the reported person are simultaneously in the first database, the reporting can be determined to be valid. When the plurality of user sub-IDs of the reported person are not simultaneously in the first database, the reporting can then be determined to be invalid.

In this case, the determination unit 402 can be configured to determine whether the plurality of user sub-IDs of the reported person are simultaneously in the first database. When the plurality of user sub-IDs of the reported person are simultaneously in the first database, the user ID of the reported person can be determined to be in the first database. When the plurality of user sub-IDs of the reported person are not simultaneously in the first database, the user ID of the reported person can be determined not to be in the first database.

Optionally, the informer can be rewarded automatically. That is, the system for processing report information can further include a third processing unit 406. The third processing unit 406 is configured to obtain an account of the informer (i.e., an account that the informer belongs to), add points to the account of the informer, and calculate total points. When the total points exceed a point threshold corresponding to a preset reward level, a reward code corresponding to the preset reward level can be sent to the informer, and points corresponding to the preset reward level can be accordingly deducted from the total points.

In addition, when the total points do not exceed a point threshold corresponding to a preset reward level, the third processing unit 406 can take no actions. Alternatively, in this case, the third processing unit 406 can be configured to send an alert message to the user (i.e., the informer) to inform him/her that the current total points are not yet enough to redeem rewards, or inform him/her of any other suitable information. Reward strategies can be set according to needs of actual applications.

During implementation, each of the above units can be implemented as a separate entity, or can be implemented in various combinations as one or more entities. The implementation of the units can be similar or the same as depicted above in various disclosed embodiments.

According to various disclosed embodiments, in an exemplary system for processing report information, a receiving unit 401 can receive a reporting from an informer, when the informer submits report information including at least a user ID of a reported person. According to the user ID of the reported person, a determination unit 402 can determine whether the reporting is valid or not. When the reporting is valid, a first processing unit 403 can punish the reported person according to preset punishment strategies, send to the informer first feedback information indicating a valid reporting, and send to the reported person second feedback information indicating reasons for punishing. When the reporting is invalid, a second processing unit 404 can send to the informer third feedback information indicating an invalid reporting. Thus, the report information can be automatically processed. Problems of high labor cost and low efficiency (caused by manually analyzing and auditing the report information) can be solved. Thus, labor cost can be saved, and processing efficiency can be significantly improved.

Various embodiments further provide a server. In various embodiments, the server can include a management server. A system for processing report information in accordance with various embodiments can be integrated in the management server. For example, FIG. 5 depicts a structure diagram of an exemplary server in accordance with various disclosed embodiments. The server can be incorporated in an environment or system architecture as depicted in various embodiments (e.g., as shown in FIG. 6).

Referring to FIG. 5, the server may include components, e.g., a processor 501 containing one or more processing cores, a memory 502 containing one or more computer-readable storage media, radio frequency (RF) circuit(s) 503, Wireless Fidelity (WiFi) module(s) 504, power supply 505 or power supplies 505, sensor(s) 506, input unit(s) 507, and/or display unit(s) 508. The structure of the server shown in FIG. 5 does not limit a server according to various embodiments. More or less components than the components as shown in FIG. 5 can be included. Certain components can be combined. Different arrangement of the components can be used. The components as depicted in FIG. 5 can be similar or the same as corresponding components depicted in various embodiments (e.g., as shown in FIG. 7).

The processor 501 can be a control center of the server, and can be configured to connect various components of the server using various interfaces and circuits. By running or executing software programs and/or modules stored in the memory 502, and by retrieving data stored in the memory 502, the processor 501 can be configured to perform various functions of the server and process data in order for an overall control of the server. Optionally, the processor 501 may contain one or more processing cores. Optionally, the processor 501 may include an application processor and a modem processor. The application processor can be configured to mainly process operating systems, user interfaces, application programs, etc. The modem processor can be configured to mainly process wireless communications. Optionally, the modem processor is not integrated into the processor 501.

The memory 502 is configured to store software programs and/or modules. By running or executing the software programs and/or modules stored in the memory 502, and by retrieving data stored in the memory 502, the processor 501 can perform various functions of the server and process data. The memory 502 may include a storage program area and a storage data. The storage program area is configured to store operating systems and application programs required by one or more functions (e.g., sound playback, image playback, etc.) or any other suitable programs to store. The storing data area is configured to store data created based on usage of the server. Further, the memory 502 can include high-speed RAM and/or non-volatile memory, e.g., at least one disk storage device, flash memory device, and/or other volatile solid-state memory devices. Accordingly, the memory 502 may also include a memory controller to provide the processor 501 with access to the memory 502.

The RF circuit 503 can be used to receive and transmit signals when receiving and transmission of information. For example, the RF circuit 503 can be configured to receive base station downlink information to send the same to one or more processors 501 for processing, and further, to send data related to uplink to the base station. Generally, the RF circuit 503 can include, but be not limited to, antenna, at least one amplifier, a tuner, one or more oscillators, subscriber identity module (SIM) card, transceiver, coupler, low noise amplifier (LNA), duplexer, etc. In addition, the RF circuit 503 can communicate with network and other devices via wireless communication. The wireless communication can use any communication standard or protocol including, but not limited to, Global System of Mobile communication (GSM), General Packet Radio Service (GPRS), Code Division Multiple Access (CDMA), Wideband Code Division Multiple Access (WCDMA), Long Term Evolution (LTE), e-mail, Short Messaging Service (SMS), etc.

WiFi is short-range wireless transmission technology. The server can receive/send e-mails and access streaming media via the WiFi module 504. The WiFi module 504 can be configured to provide wireless broadband Internet access. Although the WiFi module 504 is depicted in FIG. 5, the WiFi module 504 can be omitted according to practical applications, without limitation.

The server can further include a power supply or power supplies 505 (e.g., a battery), to supply electric power to various components. Optionally, the power supply 505 can be connected to logic of the processor 501 via a power management system, and thus achieve functions including, e.g., charge/discharge management, power consumption management, etc. The power supply 505 may further include any other suitable components, e.g., one or more DC or AC power supply, re-charging system, power failure detection circuit, power converter or inverter, etc.

The server may further include at least one type of sensor 506, e.g., light sensor, motion sensor, and/or any other suitable sensors. The server can further be configured with gyroscope, barometer, hygrometer, thermometer, infrared sensors, and/or any other suitable sensors.

The server may further include at least one input unit 507. The input unit 507 can be configured to receive inputted numbers or character information, and to generate signal input (e.g., keyboard, mouse, joystick, optical or trackball signal input) related to user settings and functional control. For example, the input unit 507 may include a touch-sensitive surface, and/or other input devices. The touch-sensitive surface, also known as a touch screen or touch panel, can be configured to collect touch operations by a user on or near the touch-sensitive surface (e.g., operations on or near the touch-sensitive surface from the user by using finger(s), a stylus, and/or any other suitable objects or accessories), and to drive corresponding connected apparatus according to preset programs. Optionally, the touch-sensitive surface may include two parts including a touch detection apparatus and a touch controller. The touch detection apparatus is configured to detect the user's touch position, detect a signal generated by the touch operation, and send the signal to the touch controller. The touch controller is configured to receive touch information from the touch detection apparatus, convert it into contact point coordinates, send the coordinates to the processor 501, and receive commands sent by the processor 501 for executing. Furthermore, the touch-sensitive surface can have various types including, e.g., a type of resistive, capacitive, infrared, surface acoustic wave, etc. In addition, in addition to the touch-sensitive surface, the input unit 507 may further include other input devices including, but not limited to, physical keyboard, function keys (e.g., volume control keys, switch keys, etc.), trackball, mouse, joystick, etc.

The server can further include at least one display unit 508. The display unit 508 is configured to display information entered by the user, information provided for the user, or various graphical user interfaces of the server. The graphical user interfaces can be formed by graphics, text, icons, videos, or a combination thereof. The display unit 508 may include a display panel, optionally, configured using liquid-crystal display (LCD), organic light-emitting diode (OLED) and/or any other suitable display methods. Further, the touch-sensitive surface can cover the display panel. When the touch-sensitive surface detects a touch operation on or nearby, the touch-sensitive surface can process the touch operation to generate data, and send the data to the processor 501 to determine the type of the touch event. The processor 501 can then provide a corresponding visual output on the display panel, according to the type of the touch event. Although the touch-sensitive surface and the display panel are depicted in FIG. 5 as two separate components to achieve input and output functions, in various embodiments, the touch-sensitive surface can be integrated with the display panel for the input and output functions.

Although not shown in FIG. 5, the server can further include at least one of camera, Bluetooth module, etc. In various embodiments, the processor 501 in the server can load the memory 502 with executable files corresponding to processes of one or more application programs, according to certain commands. The processor 501 can then run the application programs stored in the memory 502, in order to achieve various functions. The exemplary commands can include the following.

An informer submits a reporting to the server by submitting report information including at least a user ID of a reported person. According to the user ID of the reported person, it can be determined whether the reporting is valid or not. When the reporting is valid, the reported person can be punished according to preset punishment strategies, first feedback information indicating a valid reporting can be sent to the informer, and second feedback information indicating reasons for punishing can be sent to the reported person. When the reporting is invalid, third feedback information indicating an invalid reporting can be sent to the informer.

Optionally, the determining of whether the reporting is valid, according to the user ID of the reported person, can include the following steps. For example, the server determines whether the user ID of the reported person is in a first database. The first database can store a corresponding relationship between abnormal data and user IDs that is previously submitted by various application servers. When the user ID of the reported person is in the first database, the reporting is determined to be valid. When the user ID of the reported person is not in the first database, the reporting is determined to be invalid.

Alternatively, optionally, the determining of whether the reporting is valid according to the user ID of the reported person can include the following steps. For example, the server determines whether the user ID of the reported person is in a first database. When the user ID of the reported person is in the first database, the reporting is determined to be valid. When the user ID of the reported person is not in the first database, the step of determining whether the user ID of the reported person is in the first database can be repeatedly performed within a preset period of time. When, after the preset period of time elapses, the user ID of the reported person still cannot be found in the first database, the reporting can then be determined to be invalid.

Optionally, the user ID can include a plurality of user sub-IDs. In this case, the determining of whether the user ID of the reported person is in the first database can include the following steps. For example, it can be determined whether the plurality of user sub-IDs of the reported person are simultaneously in the first database. When the plurality of user sub-IDs of the reported person are simultaneously in the first database, the user ID of the reported person is determined to be in the first database. When the plurality of user sub-IDs of the reported person are not simultaneously in the first database, the user ID of the reported person is determined not to be in the first database.

Further, optionally, before receiving the report information submitted by the informer, the method can include the following steps. The abnormal data and the user IDs submitted by the various application servers are received. The corresponding relationship between the abnormal data and the user IDs can be stored in the first database according to the abnormal data and the user IDs.

Optionally, the sending of the first feedback information indicating valid reporting to the informer, and the sending of the second feedback information indicating reasons for punishing can include the following steps. The first feedback information indicating the valid reporting can be sent to the informer via a messaging server and/or a mail server. The second feedback information indicating the reasons for punishing can be sent to the reported person via the messaging server and/or the mail server.

Optionally, the sending of the third feedback information indicating the invalid reporting to the informer can include sending of the third feedback information indicating the invalid reporting to the informer via the messaging server and/or the mail server.

Optionally, after the sending of the first feedback information indicating the valid reporting to the informer, the method can further include the following steps. For example, an account of the informer (i.e., an account that the informer has or belongs to) can be obtained. Points can be added to the account of the informer. Total points can be calculated. When the total points exceed a point threshold corresponding to a preset reward level, a reward code corresponding to the preset reward level can be sent to the informer, and points corresponding to the preset reward level can be accordingly deducted from the total points. The implementation of the various steps as described above can be similar to or the same as in the methods in accordance with various disclosed embodiments.

Various disclosed embodiments provide servers to implement the methods and/or the systems disclosed herein. An exemplary server can receive a reporting from an informer. The informer can submit report information including at least a user ID of a reported person. According to the user ID of the reported person, the server can determine whether the reporting is valid or not. When the reporting is valid, the reported person can be punished according to preset punishment strategies, first feedback information indicating a valid reporting can be sent to the informer, and second feedback information indicating reasons for punishing can be sent to the reported person. When the reporting is invalid, third feedback information indicating an invalid reporting can be sent to the informer. Thus, the report information can be automatically processed. Problems of high labor cost and low efficiency (caused by manually analyzing and auditing the report information) can be solved. Thus, labor cost can be saved, and processing efficiency can be significantly improved.

Part or all of the steps in the methods in accordance with various embodiments can be accomplished using a program/software to instruct related hardware. The program/software can be stored in a computer-readable storage medium including, e.g., ROM/RAM, magnetic disk, optical disk, etc. The computer-readable storage medium is non-transitory.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods and systems can be used in a variety of Internet applications. By using the disclosed methods and systems, a reporting can be received from an informer. The informer can submit report information including at least a user identification (ID) of a reported person. It can be determined whether the reporting is valid, according to the user ID of the reported person. When the reporting is valid, the reported person can be punished according to a preset punishment strategy. First feedback information indicating a valid reporting can be sent to the informer, and second feedback information indicating reasons for punishing can be sent to the reported person. When the reporting is invalid, third feedback information indicating an invalid reporting can be sent to the informer.

Thus, the report information can be automatically processed. Problems of high labor cost and low efficiency (caused by manually analyzing and auditing of the report information) can be solved. Thus, labor cost can be saved, and processing efficiency can be significantly improved.

What is claimed is:

1. A method for processing report information, implemented by a computer system, comprising:
receiving a reporting from an informer, wherein the informer submits report information including at least a user identification (ID) of a reported person;
determining whether the reporting is valid, according to the user ID of the reported person; and
when the reporting is valid:
punishing the reported person according to a preset punishment strategy;
sending, to the informer, first feedback information indicating a valid reporting; and
sending, to the reported person, second feedback information indicating reasons for punishing; or
when the reporting is invalid:
sending, to the informer, third feedback information indicating an invalid reporting.

2. The method according to claim 1, wherein the determining of whether the reporting is valid according to the user ID of the reported person includes:
determining whether the user ID of the reported person is in a first database, wherein the first database stores a corresponding relationship between abnormal data and user IDs that is previously submitted by one or more application servers; and
when the user ID of the reported person is in the first database, determining that the reporting is valid; or
when the user ID of the reported person is not in the first database, determining that the reporting is invalid.

3. The method according to claim 1, wherein the determining of whether the reporting is valid according to the user ID of the reported person includes:
determining whether the user ID of the reported person is in a first database, wherein the first database stores a corresponding relationship between abnormal data and user IDs that is previously submitted by one or more application servers; and
when the user ID of the reported person is in the first database:
determining that the reporting is valid; or
when the user ID of the reported person is not in the first database:
returning to determine whether the user ID of the reported person is in the first database within a preset period of time; and
when the user ID of the reported person is not in the first database after the preset period of time, determining that the reporting is invalid; or
when the user ID of the reported person is detected to be in the first database within the preset period of time, determining that the reporting is valid.

4. The method according to claim 2, wherein the user ID includes a plurality of user sub-IDs, and the determining of whether the user ID of the reported person is in the first database includes:
determining whether the plurality of user sub-IDs of the reported person are simultaneously stored in the first database; and
when the plurality of user sub-IDs of the reported person are simultaneously stored in the first database, determining that the user ID of the reported person is in the first database; or
when the plurality of user sub-IDs of the reported person are not simultaneously stored in the first database, determining that the user ID of the reported person is not in the first database.

5. The method according to claim 2, wherein, before the receiving of the reporting from the informer, the method further includes:
receiving the abnormal data and the user IDs submitted by the one or more application servers; and
storing the corresponding relationship between the abnormal data and the user IDs in the first database, according to the abnormal data and the user IDs.

6. The method according to claim 1, wherein:
the sending of the first feedback information indicating the valid reporting to the informer includes sending, to the informer, the first feedback information indicating the valid reporting via a messaging server, a mail server, or a combination thereof;
the sending of the second feedback information indicating the reasons for punishing to the reported person includes sending, to the reported person, the second feedback information indicating the reasons for punishing via the messaging server, the mail server, or a combination thereof; and
the sending of the third feedback information indicating the invalid reporting to the informer includes sending, to the informer, the third feedback information indicating the invalid reporting via the messaging server, the mail server, or a combination thereof.

7. The method according to claim 1, wherein after the sending of the first feedback information indicating the valid reporting to the informer, the method further includes:
obtaining an account of the informer;
adding points to the account of the informer;
calculating total points of the account of the informer; and
when the total points exceed a point threshold corresponding to a preset reward level:
sending to the informer a reward code corresponding to the preset reward level; and
deducting, from the total points, points corresponding to the preset reward level.

8. A system for processing report information, comprising:
a receiving unit configured to receive a reporting submitted by an informer, wherein the informer submits report information including at least a user ID of a reported person;
a determination unit configured to determine whether the reporting is valid, according to the user ID of the reported person;
a first processing unit configured to, when the reporting is valid:
punish the reported person according to a preset punishment strategy;
send to the informer first feedback information indicating a valid reporting; and
send to the reported person second feedback information indicating reasons for punishing; and
a second processing unit configured to, when the reporting is invalid:
send to the informer third feedback information indicating an invalid reporting.

9. The system according to claim 8, wherein the determination unit is configured to:
determine whether the user ID of the reported person is in a first database, wherein the first database stores a corresponding relationship between abnormal data and user IDs that is previously submitted by one or more application servers; and
when the user ID of the reported person is in the first database, determine that the reporting is valid; or
when the user ID of the reported person is not in the first database, determine that the reporting is invalid.

10. The system according to claim 8, wherein the determination unit is configured to:
determine whether the user ID of the reported person is in a first database, wherein the first database stores a corresponding relationship between abnormal data and user IDs that is previously submitted by one or more application servers; and
when the user ID of the reported person is in the first database:
determine that the reporting is valid; or
when the user ID of the reported person is not in the first database:
return to determine whether the user ID of the reported person is in the first database within a preset period of time; and
when the user ID of the reported person is not in the first database after the preset period of time, determine that the reporting is invalid; or
when the user ID of the reported person is detected to be in the first database within the preset period of time, determine that the reporting is valid.

11. The system according to claim 9, wherein the user ID includes a plurality of user sub-IDs, and the determination unit is further configured to:
determine whether the plurality of user sub-IDs of the reported person are simultaneously in the first database; and
when the plurality of user sub-IDs of the reported person are simultaneously in the first database, determine that the user ID of the reported person is in the first database; or
when the plurality of user sub-IDs of the reported person are not simultaneously in the first database, determine that the user ID of the reported person is not in the first database.

12. The system according to claim 9, further including a storage unit, wherein:
the receiving unit is further configured to receive the abnormal data and the user IDs submitted by the one or more application servers; and
the storage unit is configured to store the corresponding relationship between the abnormal data and the user IDs in the first database according to the abnormal data and the user IDs received by the receiving unit.

13. The system according to claim 8, wherein:
the first processing unit is further configured to, when the determination unit determines that the reporting is valid:
send, to the informer, the first feedback information indicating the valid reporting via a messaging server, a mail server, or a combination thereof; and
send, to the reported person, the second feedback information indicating the reasons for punishing via the messaging server, the mail server, or a combination thereof; and
the second processing unit is further configured to, when the determination unit determines that the reporting is invalid:
send, to the informer, the third feedback information indicating the invalid reporting via the messaging server, the mail server, or a combination thereof.

14. The system according to claim 8, when the determination unit determines that the reporting is valid, further including a third processing unit configured to:
obtain an account of the informer;
add points to the account of the informer;
calculate total points of the account of the informer; and
when the total points exceed a point threshold corresponding to a preset reward level:
send to the informer a reward code corresponding to the preset reward level; and
deduct, from the total points, points corresponding to the preset reward level.
